(19) United States
(12) Patent Application Publication
(10) Pub. No.: US 2014/0045442 A1
(43) Pub. Date: Feb. 13, 2014

(54) ELECTROMAGNETIC FIELD TRANSMITTING AND RECEIVING ANTENNAE ARRANGEMENT

(71) Applicants: Jean-Paul Caruana, La Seyne Sur Mer (FR); Grégory Capomaggio, Roquevaire (FR); Christophe Buton, Gemenos (FR)

(72) Inventors: Jean-Paul Caruana, La Seyne Sur Mer (FR); Grégory Capomaggio, Roquevaire (FR); Christophe Buton, Gemenos (FR)

(73) Assignee: GEMALTO SA, Meudon (FR)

(21) Appl. No.: 14/111,927

(22) PCT Filed: Apr. 13, 2012
(86) PCT No.: PCT/EP2012/056847

§ 371 Date: Oct. 15, 2013

(30) Foreign Application Priority Data
Apr. 15, 2011 (EP) 11305454.8

(51) Int. Cl. H04B 1/40

(52) U.S. Cl. CPC H04B 1/40
USPC 455/78

(57) ABSTRACT

A method for minimizing an interfering current induced in an antenna receiving an electromagnetic field, where the field is generated by a transmitting antenna located near the receiving antenna. The receiving antenna is arranged relative to the transmitting antenna such that the induced current is at least partially cancelled out in the receiving antenna. The invention also relates to an antenna arrangement and to a device comprising the same.

### FIELD OF THE INVENTION

The invention relates to a method for minimising an interfering current induced in an antenna receiving an electromagnetic field by a transmitting antenna located nearby, an antenna arrangement and a device implementing the method.

The invention relates in particular to an activated contactless communication device.

The invention aims in particular to indicate the features of the signals, the antennas and the principle of this novel way to use contactless technology. The radiofrequency communication is, in principle, short range and carried out by electromagnetic coupling and induction with a range of the order of 0.01 or 1 m.

The invention can be used in particular in portable electronic objects, for example in memory cards, such as SD cards (by the company SanDisk), and in watches with communication capabilities.

Such cards are currently used in a mobile telephone card interface for performing contactless transactions in compliance mainly with standard ISO/IEC 14443 or 15693, whenever said telephones are not provided with a contactless interface ex-factory.

### PRIOR ART

Existing ISO/IEC 14443 and NFC (Near Field Communication) technology is based on a principle of retro-modulation of a signal transmitted by a reader.

According to said principle, a certain amount of the electromagnetic field supplied by a reader should be modulated by the object with the proximity contactless chip, also referred to as PICC (Proximity Integrated Circuit Card). In order to comply with the sensitivity of the reader, the field should have a minimum field amplitude in order to be modulated by the object. Said modulation of the reader carrier should generate two sidebands with an amplitude no lower than H/2^{0.5}. In order to meet this condition, a minimum coupling must be provided between the reader and the object in order to generate enough of a carrier signal.

The coupling factor depends directly on the surfaces of the reader antenna and of the contactless object.

In the case of a very small contactless objects—for example a Micro SD card—the surface of the radiofrequency antenna is extremely small. In addition, this type of object is intended for being installed in a host device such as a mobile telephone. The latter operation further reduces the coupling of the contactless object with the reader due to the metal environment of the telephone.

Patent EP1801741 (B1) describes a method for generating a specific electromagnetic field by a portable data medium (transponder), in which data are transmitted to a reader in an activated communication mode, and in which the reader sees the transmission of the specific electromagnetic field as a modulation of the field of the reader. However, this solution does not appear to be completely described or does not work correctly as described.

In addition, the teaching of this patent is very complicated. The implementation of same requires further electronic components, in particular filters, an oscillator and an NFC component. Moreover, existing NFC controllers require two antennas, one for collecting energy and the other for transmitting/receiving data.

A means capable of avoiding mutual interference between antennas is also known, which consists of deactivating the receiving antenna not used during the transmission by the transmitting antenna.

The latter case is particularly complicated to manage, since the object in question must synchronise both the frequency and the phase of its response with the signal transmitted by the reader. In this case, with the receiving signal momentarily deactivated, the object in question needs to use complex, expensive electronic devices which are difficult to build into small form factors, in order to make up for said loss of synchronisation, for example such as phase locked loop devices, known as PLL.

Patent application US2010/0311328 describes a contactless card which includes a data-transmitting antenna, an energy-receiving antenna and a cancellation device. The latter cancels out a current induced in the transmitting antenna by the transmitting antenna such as to maintain, with almost no distortion, a signal received by the receiving antenna coming from an external reader. In one embodiment, the receiving and transmitting antennas are shaped, sized and positioned relative to one another such that a signal transmitted by one antenna is prevented from inducing a voltage in the other antenna. Signal suppression occurs when the energy and data signals have the same amplitude but opposite phases.

The invention aims to find an easier, advantageous solution for implementing a transmission in mainly small objects in which two separate antennas can have interfering mutual inductions.

### SUMMARY OF THE INVENTION

For this purpose, the invention thus relates to a method for minimising an interfering current induced in an antenna receiving an electromagnetic field, said field being generated by a transmitting antenna located near said receiving antenna.

The method is characterised in that the receiving antenna is arranged relative to the transmitting antenna such that said current induced by the transmitting antenna is at least partially cancelled out in the receiving antenna by an opposite induced current which is also generated by the transmitting antenna.

According to other features of the method:
said antennas are arranged partially opposite one another on two substantially parallel horizontal planes;
the antennas overlap, with around half of the coupling surface of the receiving antenna substantially covering the coupling surface of the transmitting antenna;
the receiving antenna overlaps the transmitting antenna such that the current induced in the receiving antenna generated by a flux produced inside the transmitting antenna is substantially equal to the opposite current induced in the receiving antenna generated by a flux in the opposite direction produced outside of the transmitting antenna and received by a portion of the receiving antenna located outside of the transmitting antenna.

The invention also relates to an antenna arrangement transmitting and receiving an electromagnetic field, said antennas being arranged near one another.

The arrangement is characterised in that the receiving antenna is arranged relative to the transmitting antenna such that said current induced by the transmitting antenna is at least mostly or almost entirely cancelled out in the receiving antenna by an opposite induced current also generated by the transmitting antenna.

Thus, the invention can cancel out the induction in part, for example more than 60%, 80% or 90%.

According to other features of the invention:
the antennas are arranged such that the electromagnetic flux of the transmitting antenna passes through a first portion of the coupling surface of the transmitting antenna in one direction and an opposite flux passes through a second portion of the coupling surface of the receiving antenna in an opposite direction;
the antennas are arranged on the same surface of a medium or on opposite surfaces;
one of the antennas overlaps the other over half of the coupling surface thereof.

The invention also relates to a radiofrequency communication device implementing the above method or including the above antenna arrangement.

In particular, in the case of activated contactless communication, the device includes a means for receiving and transmitting an electromagnetic field carrying data, the transmission being synchronised with said reception. The device is characterised by having a first antenna for receiving data and a second antenna for transmitting data, arranged in accordance with the above arrangement.

The device can be installed in or make up an object having the form factor of an integrated circuit card such as a Micro SD card or a watch.

The invention ensures good coupling in particular between a reader and a PICC object (SD card). Moreover, it is easy to implement with minimum modifications. The invention applies, in particular, to any standard dual-interface chip (with or without an oscillator).

### BRIEF DESCRIPTION OF THE FIGURES

FIG. 1 shows an SD card including the circuit according to one embodiment of the invention;

FIG. 2 shows a more detailed view of the radiofrequency circuit RF of the preceding figure;

FIG. 3A shows a first embodiment of a receiving stage of FIG. 2;

FIG. 3B shows a second embodiment of a receiving stage of FIG. 2;

FIG. 4 shows an embodiment of a transmission stage of FIG. 2;

FIGS. 5 and 6 show a receiving antenna arranged relative to a Micro SD card and equivalent circuit values of the antenna;

FIG. 7 shows the level of modulation by the radiofrequency component SE (5);

FIG. 8 shows a filter for extracting the response signal of the component 5 from the carrier of the preceding figure;

FIG. 9 shows a circuit combining the carrier and the response signal only;

FIG. 10 shows a circuit LC relative to the transmitting antenna;

FIG. 11 shows values of the reactances X_{L} and X_{C} respectively according to the inductance and the capacity as a function of the frequency;

FIG. 12 shows an arrangement of a transmitting antenna relative to a Micro SD card and a mutual arrangement of the two antennas.

### DETAILED DESCRIPTION

Activated communication is understood to refer to contactless communication wherein the response of a transponder is provided by transmitting an electromagnetic field that is specific to the transponder, preferably amplified. Said transmission is actually obtained by transmitting, with predetermined power, a carrier signal modulated by a signal of the transponder.

The amplification and/or operation energy of the transmitting/receiving transponder is preferably provided by an external power source that is separate from the reader.

The communication or the contactless circuit typically comply with standard ISO/IEC 14443 and/or ISO/IEC 15693 or any other protocol based on an electromagnetic field activation frequency of 13.56 MHz. The circuit is powered by a current source.

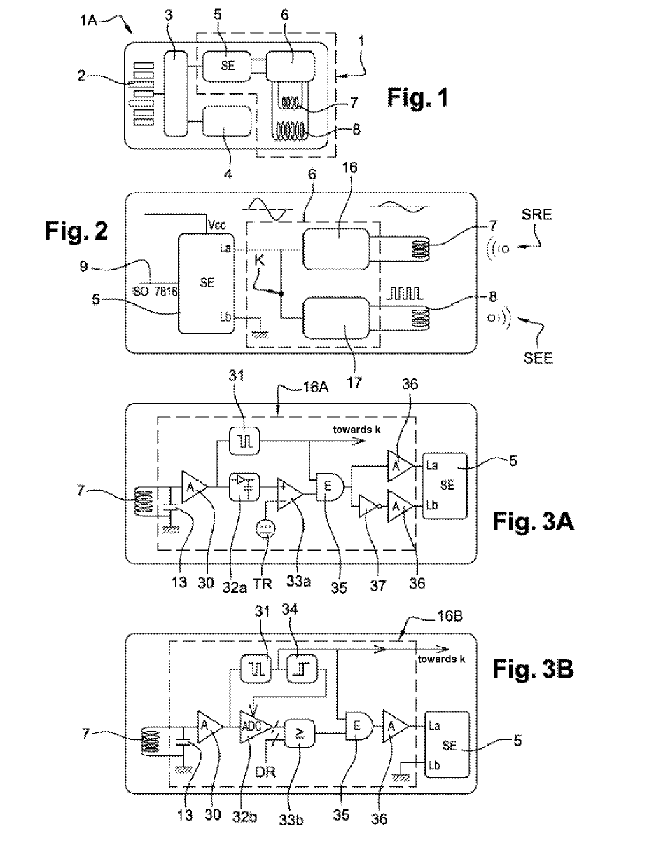

FIG. 1 shows an example of an embodiment of a contactless communication circuit 1 according to the invention provided in a memory card 1A. However, any other communication-enabled object can, in principle, be provided with such a card, for example a USB drive, a PCMCIA card, a telephone, a PDA, a computer, etc.

The object can optionally be removable from a host device or permanently attached thereto, in particular soldered to the printed circuit card. The circuit or the object can, if need be, provide connections to external antennas instead of supporting same.

The memory card 1 includes, in a known manner, contact studs 2, a microcontroller 3, and a Flash memory 4 (NAND) connected to the microcontroller. The card also includes a communication processing element 5. The card is preferably of the dual-interface type (configured such as to manage contact communication—for example ISO 7816-3—and contactless communication—ISO-14443 (SE)). Said component or element 5 (SE) is preferably secured, like an integrated circuit chip known in the field of chip cards. It can be provided, if need be, with cryptographic, anti-fraud and/or anti-intrusion functionalities, among others.

The component SE is connected to the microcontroller 3 by an input/output port. The security component SE is connected to an active CL interface circuit 6. Said component 6 comprises two antennas 7 and 8, for receiving and transmitting, respectively.

In principle, the invention can be seen to include an additional RF means 6, 7, 8 added to the contactless element SE in order to make up for the particularly small size of the antenna, since it is housed in a Micro SD (11×15 mm) or Mini SD card or in an object of a substantially similar size.

According to one feature of an embodiment of the invention, the transmission means 5, 6, 7, 8 is configured such as to modulate a carrier signal 25. Said carrier signal in this case is preferably derived or extracted from the magnetic field received from an external reader.

In the example, the radiofrequency circuit 6 performs functional activities of receiving and transmitting the electromagnetic field described below. In particular it picks up the external radiofrequency field RF from a contactless reader such as to, if necessary, make said field compatible with the secured component SE (voltage, etc.). It amplifies the reply of the secured element SE intended for being picked up by the external reader.

FIG. 2 describes the component SE (5) and the connections thereof in greater detail. The circuit SE of said embodiment includes a means for connecting to an external power source.

In the example, the component SE includes a contact interface, for example in compliance with standard ISO-7816, symbolised by a connection bundle 9, which includes a supply stud Vcc, and studs La, Lb respectively connected to an active interface 6 and to the earth. The component SE is configured such as to modulate an impedance charge in response to the reception of contactless frames received on the studs La, Lb thereof.

The active interface 6 includes a circuit 16 for conditioning the reception signal SRE and a circuit 17 generating pulses for transmitting a transmission signal SEE. Each circuit 16, 17 is connected to the stud (La) of the processing component 5.

According to one embodiment of the invention, the transmission means 5, 17 is configured such as to modulate a carrier signal. The carrier signal is preferably the result of a derivation or extraction of the received magnetic field SRE.

Clock and Data Reception.

According to one embodiment, the method includes a step of receiving the carrier frequency generated by the reader. The carrier frequency is received by a dedicated receiving antenna 7. The antenna 7 actually receives the electromagnetic field transmitted by the reader including the modulated carrier frequency. In the example, the frequency is 13.56 MHz, but it could be any other according to the type of communication or protocol, using said 13.56 MHz frequency as the basis for a short or medium range, in particular less than 10 m, 1 m or 0.1 m, even close to 0.

However, the invention does not exclude the possibility of generating a carrier signal by any other means, for example according to a clock signal or an internal signal of a host device or of the object.

Said receiving step also aims to collect the data sent by the reader to the contactless object. An electronic stage including a dedicated receiving circuit can be produced for said purpose, in particular in order to adapt the voltage.

The method can also implement a step of adaptation by means of a reception adaptation stage (16) in order to adapt the reception signal SRE to the chip 5. In this stage, the method can, cumulatively or in alternation, extract the synchronised carrier signal 25 from the reception signal SRE.

FIG. 3A shows a first detailed embodiment 16B of stage 16. The receiving stage 16A includes the receiving antenna 7, in this case connected to the stud ‘La’ of the chip via a receiving circuit described below.

The signal received by said antenna can be amplified before extracting the clock signal corresponding to the signal of the carrier. For this purpose, the circuit includes an amplifier connected to the antenna and a clock extractor 31 is connected to the output of said amplifier.

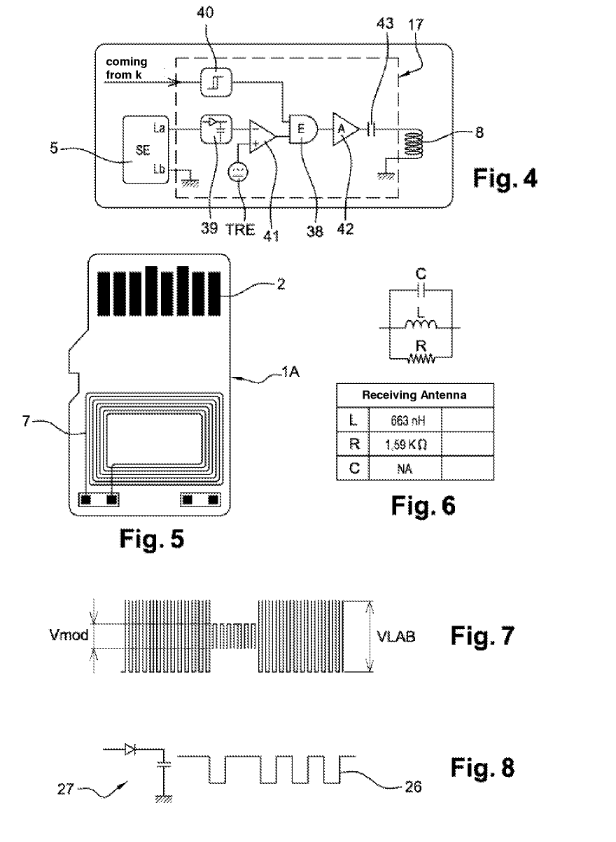

The clock signal 25 obtained at the output of the extractor is sent via a link (K) to a pulse-generating circuit or transmission-adaptation stage 17 described in detail in FIG. 4. The output of the clock extractor 31 is furthermore also connected to a logic circuit 35 performing an “AND” function.

The stage 16A in this case also includes a demodulator 32a receiving the receiving signal SRE amplified by the amplifier 30 connected to a comparison circuit 33a in order to compare the demodulated signal obtained with a reference voltage (TR).

Then, the comparator output signal 33a is combined with the clock signal 25 from the clock extractor 31 in a component performing an “AND” logic function. A first branch of the output of the component 35 can pass through an amplifier 36 before being injected into the stud ‘La’ of the chip 5.

A second branch of the output of the component 35 can pass through an inverter and then an amplifier 36 before being connected to the stud ‘Lb’ of the chip.

FIG. 3B shows a second embodiment 16B of said stage 16 in which the component 5 used is also a chip with dual contact and contactless interface (combi). The same numbers from one figure to the next depict identical or substantially similar features.

In this embodiment, the clock extraction circuit is also connected to a phase shifter 34 before engaging with the analog-to-digital converter 32b.

The receiving stage or circuit 16B is connected by one end to the receiving antenna 7, which in this case is connected to stud ‘La’ of the chip. The circuit 16B can include a capacitor 13 arranged on the terminals of studs ‘La’ and ‘Lb’ of the chip. This capacitor makes it possible to achieve a good quality factor. The resonant circuit of the receiving antenna is based on the parallel circuit principle.

Unlike in the circuit 16A, the demodulator 32a is replaced with an analog-to-digital converter 32b, the comparator 33a is replaced with a digital comparator 33b having a digital reference value (DR) and the stud ‘Lb’ is connected to the earth instead of receiving the “AND” output signal of the circuit, inverted and amplified by an inverter 37 and an amplifier 36, respectively.

In addition, said circuit includes a phase shifter 34 on an output branch of the clock extractor 31. Said phase shifter is then connected to the analog-to-digital converter 32b.

Thus, said stages 16A or 16B each make it possible to extract the clock signal 25 and to adapt the signal to the chip 5. After reception and amplification, the carrier signal is directed towards the RF input of the combi chip 5 using the interface studs La/Lb. An additional capacitor 18 can be added to the interface in order to adapt the input impedance.

The electronic stages 16A and 16B operate as follows:

The signal SRE received by the antenna 7 can be quite weak considering the small coupling surface of the antenna 7 in a medium such as a Mini SD card.

Said signal is amplified by the amplifier 30 prior to being demodulated by the demodulator 32a or analog-to-digital converter 32b. A useful signal extracted and calibrated by the comparator is combined by the (AND) gate 35 with the clock signal extracted by the clock extractor 31. At the output of the gate 35, the reconditioned radiofrequency signal is injected into the component 5 after being amplified in differential mode previously by means of the inverter 37 and the amplifiers 36.

At the same time, the power supply Vcc of the chip on the contact side ISO 7816 can be deactivated by a suitable circuit (not shown) during the presence of an electromagnetic field SRE. Said latter circuit can be included in the circuit 16A or 16B. The activation can be manual.

The components (30, 36, 32a, etc.) of said circuits can preferably be powered by voltage from the contacts 2 in relation with a host device.

The circuit 16B has substantially similar operation. However, the phase shifter 34 makes it possible accurately to adjust the activation of the radiofrequency signal acquisition in order to convert the envelope of the received signal into a digital signal via the converter 32b.

The “combi” chip 5 can either by powered by the ISO/IEC 7816 contact studs Vdd and Vss thereof, or use power supplied by the field to the interface studs La, Lb thereof according to the use and electronic assembly of the invention. The chip can also be supplied by a voltage, generated in the image of the RF field, or by the actual circuit 16, powered by the contacts 2 of a host device.

The advantage of this latter option is that the power supply of the component can be managed by the stage 16 according to whether or not the field is present and, if need be, the chip 5 can be reset.

At this stage, the voltage amplitude VLab is at least 3.3 Vpp (peak-to-peak volts). This value is necessary in order for the chip of the example to detect the 13.56 MHz clock and be able to extract data from the reader.

By way of example, the following table shows the voltage that two existing chips—P5CD072 by Philips/NXP or 66CLX800 by the company Infineon—require in order to detect the clock and the data from the external field.

Chip

| | Contactless chip | Contactless chip |
|---|---|---|
| | V DC = 3 V | V DC = 2.7 V |
| Vmin (Vpp) | 3.48 | 3.53 |
| Vmax (Vpp) | 6.87 | 6.22 |
| Duty cycle (%) | 7.7 | 7.7 |

Receiving Antenna (FIG. 5, 6).

The receiving antenna 7 is as wide as possible within the limit of the surface available in the object. In the context of a surface available on a Micro SD card, the results presented below were used. The inductance is preferably selected such as to be tuned by a low-value additional capacitor in order to limit the size of the capacitor.

The receiving antenna can, for example, have a surface area of 5×5 mm² and include 4 to 6 turns. The antenna can be adjusted to 13.56 MHz with a quality factor Q of 10. A parallel circuit can be selected such as to obtain a maximum voltage on the terminals of the antenna circuit. The following antenna specifications have been selected with the equivalent circuit of FIG. 6, wherein L=663 nH, R=1.59 KQ, and C is not applicable.

The performance of the antenna measured with such an antenna using the equivalent diagram of FIG. 6 is provided in the table below.
Ls=663 nH, Rs=1.59 KΩ, Cl=180 pF, C2=18 pF, Rc 270 KΩ, Cp=9.5 pF, Rp=1 MΩ.

| Field | Contactless chip |
|---|---|
| intensity | V DC = 2.7 v |
| 1.5 A/m | 1.01 Vpp |
| 4.5 A/m | 3.00 Vpp |
| 7.5 A/m | 5.09 Vpp |

The voltage expected with this antenna is higher than 5.1 Vpp (peak-to-peak volts). The minimum field creates a voltage of more than 1 Vpp, not enough for the combi chip 5 to detect the signal. This is why an amplification stage was preferably added to the embodiment with a Micro SD card. Said amplification stage for receiving the clock is, in this case, higher than 10 dB, the voltage gain being equal to 3. This amplification may not be necessary in other circumstances or with other chips.

The output level of the conditioning stage 16 is from 3 Vpp to 14 Vpp. The gain can be from 5 dB to 20 dB.

The chip can be switched off or reset by any means, such as a switch in the host device or on the power circuit of the chip. The chip resets automatically when it is powered up.

Sideband and Modulation (FIG. 7-10).

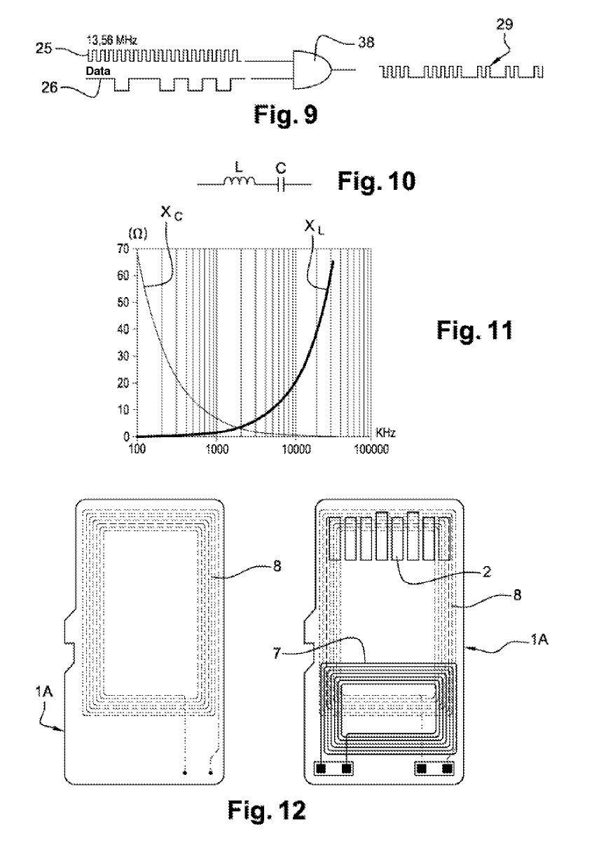

In the example (FIG. 9), when the combi chip 5 receives the carrier signal (or the carrier) as well as the data signal via the studs La/Lb thereof, it generates a charge modulation signal in order to send a response to the device or terminal with which it communicates. The amplitude of the modulation signal Vmod in this case is around half the amplitude of the carrier VLAB when the capacitor is correctly adjusted.

A capacitor of 10 to 60 pF at the terminals of the points La, Lb of the chip can be used for this purpose. This value can vary according to the type of chip. Thus, VLAB and Vmod voltages are obtained which are equal to 3.3 peak-to-peak volts and 1.6 peak-to-peak volts, respectively.

In this step, two options are possible. The first most straightforward option is to use said signal as presented and then, preferably, to amplify same in a high-power amplification stage prior to injecting the signal into a circuit for adapting or adapting the transmission 17 upstream from the transmitting antenna 8. Different amplification means which are known in the prior art can be used.

In another example (FIG. 8), in accordance with a second option, the carrier signal for the transmission is eliminated in order to keep the digital data 25. For this purpose it is possible to use, for example, a low-pass filter 27 of FIG. 8.

Subsequently (FIG. 9), modulation is carried out, preferably to 100% by combining the data signal 25 with a carrier 26 at 13.56 MHz. This can be done with the assistance of the (AND) logic gate 38 or an amplifier buffer 42 or a transistor assembly performing the same function. After power amplification, the obtained signal 29 is used to power the output antenna 8.

Thus, rather than amplifying the assembly including the carrier 25 and the signal 26 or the carrier only 25 even when there is no signal, the invention provides for amplifying the signal and the carrier only when there is a response signal. For example, in the present case in FIG. 9, the useful signal 29 is amplified when the data signal has a high level. When there is no signal (data line at a level of zero or near zero), no signal comes out of the gate 38. There is no amplification or waste of energy of the carrier only prior to powering the transmitting antenna.

FIG. 4 shows a relatively straightforward preferred embodiment which makes it possible to obtain good results by partially implementing the second option. According to said preferred option, the adaptation stage 17 includes an “AND” logic gate 38 or an equivalent circuit for combining a carrier signal 26 (FIG. 9) and a response signal 25 or transmission signal of the chip 5 prior to amplification.

In greater detail, in the circuit 17, the stud ‘La’ of the chip 5 is connected to a demodulator 39 (which can be of the same type as the circuit 27 or 32a) in order to receive a modulated response signal from the chip 5. Then, the output of the demodulator 39 connects a comparator 41 which compares the received voltage level with a reference voltage level (TRE) in order to digitise the useful signal. The output of the comparator 41 carrying the useful response signal of the chip 26 is connected to one of the inputs of the component 38 performing the “AND” logic function in order to combine the carrier signal 25 with the response signal 26 of the chip.

The carrier 25 comes from the point K of the stage of adapting the reception and extraction 16A or 16B. The carrier is injected via a link to the other input stud 15 of the component 38 performing the “AND” logic function. The clock signal is preferably phase-shifted by a phase shifter 40 such as to synchronise or lock the clock signals optimally with the carrier of the radiofrequency signal generated by a reader device in order to produce maximum retro-modulation.

The circuit 17 preferably includes an amplifier or buffer circuit 42 for amplifying the signal 29 at the output of the component 38 before injecting same into the transmitting antenna 8. The antenna circuit used forms a serial resonant circuit with a capacitor 43.

Certain components of the stage 17 can preferably be powered, for the operation thereof, by a power source from the host device via the contacts 2. Other sources which are known in the prior art are not excluded.

The circuit 17 operates as below. After the chip has received radiofrequency frames SRE which have preferably been previously reconditioned on the points La, Lb thereof, the response of the chip by charge modulation is received and demodulated in the demodulator 39. Then a useful signal is digitised by the threshold comparator 41 before being injected into the (AND) circuit 38 and combined with a carrier 25 extracted or derived from the received field SRE from the point K. If need be, the circuit 17 can include a clock extractor similar to 31 collecting the signal as in FIG. 16A or 16B.

The response signal 29 from the circuit 38 is then amplified, preferably by the amplifier 42, before being injected into the transmitting antenna with serial resonance 8.

Power of the Output Buffer Amplification.

In order to make up for the small surface of the transmitting antenna in the SD card (or other substrate), an output buffer amplifier 42 can be used, which preferably produces a minimum current of 60 mA to 80 mA with the supply voltage provided. Good results are obtained with a power of more than 200 mW.

One advantage of said treatment is, in particular, limiting the power consumption of the amplification when no response signal is received from the chip 5. It is, indeed, pointless to amplify the signal of the carrier only when there is no response or signal to be transmitted in the foreseen application.

Output Antenna & Frequency Tuning (FIG. 10, 11).

The antennas 7, 8 in the example include turns in a flat arrangement on a single substrate (or two separate substrates) as shown in particular in FIGS. 3 and 13. All known means can be used to manufacture the antenna, such as engraving, wire incrustation by ultrasound, etc.

When the system is powered with a low voltage (3.3 V), the output antenna is designed to perform a serial resonance. When the system is powered with a strong current, the voltage within the total LC circuit is relatively weak, when a high voltage is present on each component L and C.

The curve depicted in FIG. 11 shows obtained reactance values X_{L} in accordance with the inductance and thus reactance values X_{c} in accordance with a capacitor depending on the frequency through application of the following formulas:

X_{C}=1/(2·π·f·C) X_{L}=2·π·f·C

The reactances X_{L} and X_{C} are equal at the intersection point between the two curves. F is the serial resonant frequency of the circuit.

At this point, the voltage on the terminals of the LC circuit (FIG. 10) is minimal when the current intensity is maximal. Since the magnetic flux is directly dependent on the intensity of the current, this serial resonance is one way to create a high magnetic field on the transmitting antenna 8 even when the latter is powered by a low voltage.

This is a way to increase the power of the signal of the transponder 5 despite the small size of the antenna on the substrate.

Specifications of the Transmitting Antenna (FIG. 12).

According to the embodiment of the invention, the circuit includes separate receiving and transmitting antennas. The antennas are arranged together such that the mutual inductance thereof is minimal or at least partially cancelled out. The arrangement is preferably selected such as to have a minimal current induction in the receiving antenna which is, in particular, lower than the gain threshold of the receiving stage 16. For example, with a gain of 3 it is provided for arranging the antennas with one another such as to have a voltage of less than 300 mV.

For example, the antennas can be arranged such as to have a current induction in the receiving antenna that is lower—in a proportion of 1/100—than the current induction which would be generated by a reader transmitting a field level of 1.5 A/m.

In an alternative embodiment (not shown), the antennas are protected from one another by being separated from one another and/or by shielding.

In another alternative embodiment, the antennas overlap and an electronic protection means is provided, such as filters configured to prevent mutual interference.

In the advantageous embodiment, the transmitting antenna 8 is larger than the receiving antenna. The antenna is, for example, placed on the rear side of the Micro SD card, as shown in FIG. 12. The specifications thereof used in the example are: L=1.05 μH, R=939Ω, C=2.69 pF.

In order to prevent crosstalk between the antennas due to the inevitable coupling therebetween, the antennas are arranged such that the mutual inductance 20 between the two antennas is reduced to the minimum. Various solutions are possible, in particular insulating one antenna relative to the other, deactivating one antenna while the other is active, and vice-versa.

In a preferred embodiment, said feature of minimised mutual induction is obtained by overlapping or stacking the two antennas. The receiving antenna 7, which is larger in the example, is arranged such as to have substantially one portion arranged outside of the outer periphery of the transmitting antenna. The receiving antenna 7 is preferably substantially straddling the transmitting antenna, with half on one side and within the periphery of the transmitting antenna 8 and the other half outside of the periphery of the transmitting antenna.

Thus, thanks to said special arrangement, two antennas are provided in which the resultant of the mutual inductance is zero overall, or at least minimised.

When the transmitting antenna transmits an electromagnetic field, a portion of the flux F passes in a direction X through a portion A of the antenna 7 located opposite the inside of the transmitting antenna 8, generating an induced current (i) in the antenna 7.

At the same time, another portion of the flux F passes through a portion B of the antenna 7 located outside of the surface of the transmitting antenna 8 in a direction Y opposite to X, generating an induced current (j) opposite to (i).

Thus, partial overlapping of the antennas reduces at least the value of an interference caused by the transmitting antenna 8 on the receiving antenna 7.

The interference induced in the receiving antenna by the transmitting antenna cancels itself out at least to a great extent. The resultant can be substantially zero overall according to the adequate position of the antennas and the specifications thereof.

The effectiveness of self-cancellation can depend on the environment immediately outside the antenna, for example such as the metal environment of a telephone or host device of the object 1. The antennas can be on the same surface of a substrate and insulated from one another, or on opposite surfaces. The antennas can also be arranged on mutually parallel separate substrates.

The invention can contemplate implementing the following features for the described advantages:
a means for recovering or extracting from the carrier the magnetic field received in order to enable an active modulation function with no oscillator using conventional contactless chips (not NFC);
an arrangement of antennas separated with a mutual inductance of zero or almost zero, simplifying the circuit;
the implementation of two types of resonance (preferably parallel for reception and preferably serial for transmission) for increased effectiveness;
a level-adaptation circuit 16 connected to the combi chip 5 making it possible to use existing chips, in particular dual-interface chips (bank combi) which are already certified, with no modification by simplification and by industrial convenience. In particular, the invention provides for using the antenna interface La/Lb of the existing combi chip (in particular the SLE 66CLX800PE chip by the company Infineon) for modulating/demodulating;
moreover, the invention does away with the need to use an NFC chip or component, in particular with a built-in oscillator (for example, a contactless chip that complies with standard ISO/IEC 14443 and/or ISO/IEC 15693 may be used);
the circuit can include a detector configured to supply a signal representing the presence of an external magnetic field and to activate one operating mode between a contact mode and a contactless mode;
as an alternative embodiment, one and/or the other of the antennas can already be built into a host device, the circuit of the invention without the antennas simply being connected to one of the antennas via a connector (not shown) for greater adaptability of the circuit to the host devices.

Thus, the invention relates to any communication device or appliance including the circuit described above, whether removable or not.

The invention can also relate to any device including separate transmitting and receiving antennas. Thus, for example, in a small space such as the lock of an electronic door with radiofrequency activation. It is foreseen, in a passive operating mode of the lock, for the latter to receive a radiofrequency signal transmitted by a reader such as a mobile telephone or a portable transmitting key.

In another optionally activated operating mode, the lock includes a transmitting antenna arranged in accordance with the invention which is capable of reading a passive transponder such as a contactless chip card, an RFID tag or the like.

By means of the antenna arrangement of the invention, the transmission of a reading field by the transmitting antenna arranged near the receiving antenna induces a resultant interfering current which is minimal—zero or almost zero—in the receiving antenna. Thus, the arrangement of the invention makes it possible to cancel out harmful induction effects between the antennas without adding electronics or a means for deactivating or filtering the signals perceived by the receiving antenna.

The antennas can also be arranged in non-parallel planes, for example perpendicular. The receiving antenna 7 can be located, in particular, in a plane near an outer or inner turn of the transmitting antenna, the plane of the antenna 8 substantially crossing a perpendicular bisector of the coupling surface of the receiving antenna for optimal attenuation of the interference caused by the transmitting antenna.

1. Method for minimizing an interfering current induced in an antenna receiving an electromagnetic field, said field being generated by a transmitting antenna located near said receiving antenna, wherein the receiving antenna is arranged relative to the transmitting antenna such that said current induced by the transmitting antenna is at least partially cancelled out in the receiving antenna by an opposite induced current also generated by the transmitting antenna.

2. Method according to claim 1, wherein said antennas are arranged partially opposite one another on two substantially parallel horizontal planes.

3. Method according to claim 1, wherein the antennas overlap, such that approximately half of the coupling surface of the receiving antenna substantially covers the coupling surface of the transmitting antenna.

4. Method according to claim 1, that wherein the receiving antenna overlaps the transmitting antenna such that the current induced in the receiving antenna generated by a flux produced inside the transmitting antenna is substantially equal to the opposite current induced in the receiving antenna generated by a flux in the opposite direction produced outside of the transmitting antenna and received by a portion of the receiving antenna located outside of the transmitting antenna.

5. Arrangement of antennas transmitting and receiving an electromagnetic field, said antennas being arranged near one another, wherein the receiving antenna is arranged relative to the transmitting antenna such that a current induced by the transmitting antenna is substantially cancelled out in the receiving antenna by an opposite induced current also generated by the transmitting antenna.

6. Antenna arrangement according to claim 5, wherein said antennas are arranged partially opposite one another on two substantially parallel horizontal planes.

7. Antenna arrangement according to claim 5, wherein one of the antennas overlaps approximately half of the coupling surface of the other antenna.

8. Antenna arrangement according to claim 5, wherein the antennas are arranged such that the electromagnetic flux of the transmitting antenna passes through a first portion of the coupling surface of the transmitting antenna in a first direction and an opposite flux passes through a second portion of the coupling surface of the receiving antenna in a direction opposite to the first direction.

9. Antenna arrangement according to any claim 5, wherein the antennas are arranged on the same surface of a medium or on opposite surfaces.

10. Radiofrequency communication device implementing the method according to claim 1.

11. Communication device according to claim 10, wherein communication is activated and contactless, and the device includes a means for receiving and transmitting an electromagnetic field carrying data, said transmission being synchronised with said reception, further including a first antenna for receiving data and a second antenna for transmitting data, which correspond to the transmitting and receiving antenna, respectively.

12. Communication device according to claim 11, wherein the device is installed in or forms an object having the form factor of an integrated circuit card, a Micro SD card or a watch.

13. Radiofrequency communication device including an antenna arrangement according to claim 5.
